(19) United States
(12) Patent Application Publication
(10) Pub. No.: US 2005/0108152 A1
(43) Pub. Date: May 19, 2005

(54) Financial brokering method

(76) Inventors: Michael Tsoa-Lee, Wyee (AU); Trent Tsoa-Lee, Newport (AU)

Correspondence Address: Gordon & Jacobson, P.C., 65 Woods End Road, Stamford, CT, 06905, US

(21) Appl. No.: 10/966,615

(22) Filed: Oct. 15, 2004

(30) Foreign Application Priority Data
Oct. 16, 2003 (AU) 2003905655

(51) Int. Cl. G06F 17/60

(52) U.S. Cl. 705/38

(57) ABSTRACT

The present invention provides a method for providing brokering services by a broker to a customer. The method includes the step of entering into an agreement with the customer, the agreement including a promissory obligation by the broker to pay to the customer an amount based on a commission payable to the broker by a financial product supplier of a financial product, the financial product being selected by the customer, and a promissory obligation by the customer to pay a service fee to the broker. The service fee is based on value of brokering services provided.

### BACKGROUND OF THE INVENTION

1. Field of the Invention

The present invention relates to an improved method for providing brokering services. It will be described with reference to a method for mortgage brokering.

2. Related Art

The service of mortgage brokering typically involves a service provider that is an independent third party (hereinafter ‘Mortgage Broker’), who works with mortgage lenders to obtain mortgage loans for prospective borrowers (hereinafter ‘Customers’) in exchange for commissions from lenders.

Mortgage lenders can be banks or mortgage companies (eg, Aussie Home Loans). Mortgage lenders take applications, process the loan, underwrite the loan, fund the loan, and collect mortgage payments. Mortgage brokers act as intermediaries, assisting in negotiating contracts between borrowers and mortgage lenders. They take loan applications and send them to affiliated mortgage lenders for final approval, funding and servicing.

There are two types of commissions paid to mortgage brokers: an up-front commission and a trail commission.

An up-front commission is a percentage payment based on the size of borrowings and paid to the mortgage broker by the lender that the loan is underwritten by. The more the customer borrows, the more the mortgage broker profits from brokering services.

A trail commission is a percentage payment to the mortgage broker paid at monthly to annual intervals (dependant on lender) on the balance of the loan outstanding. The longer a loan remains outstanding and the greater the outstanding balance is, the more income a broker will derive from that loan.

Most mortgage brokers offer products from multiple lenders, so customers should be able to consider multiple products and lenders in one visit to (or from) the mortgage broker. The mortgage broker should be able to select the best loan product for the customer, considering all relevant aspects of the customer's needs and matching them to the various lenders and products that they have at their disposal. These factors range from the borrowing capacity of the customer and acceptable income types through to the size and type of property that lenders will accept as security.

However, the above identified objectives are difficult to achieve due to the fact that the mortgage brokering industry is largely unregulated. In particular, there is no regulation over the following aspects of mortgage brokering:
The minimum number of lenders or products offered by a broker. It is possible for a broker to have a broker agreement with only a single lender and offer no real choice to prospective borrowers;
Disclosure of commission arrangements between lenders and brokers. Most brokers do not disclose the rate of commission paid by the lender to the broker and similarly, do not disclose the rates of commission paid by all lenders on their panel. Additionally, some lenders offer brokers the option to increase the interest rate paid by the customer for a share (up to 100%) of that increased rate. As a consequence, a broker may, either deliberately or inadvertently favour a particular lender due to higher commissions.

In addition to the above issues there are many other concerns including current industry practice that determines commissions paid to brokers based on the amount borrowed. As a consequence, the more that a customer borrows, the more the broker is paid. This poses the risk that customers are encouraged to borrow more than they need, or, equally important, not actively encouraged by the broker to borrow conservatively. This also applies to trail commissions.

As a result, these fundamental features of the traditional mortgage brokering often lead to such undesirable outcomes as poor loan selection, placement with a lender paying the highest rate of commission, and inappropriate borrowing.

The present invention aims to address one or more of these deficiencies by providing a new method for providing brokering service.

Any reference herein to known prior art does not, unless the contrary indication appears, constitute an admission that such prior art is commonly known by those skilled in the art to which the invention relates, at the priority date of this application.

### SUMMARY OF THE INVENTION

In one aspect, the present invention provides a method for providing brokering services by a broker to a customer, said broker being associated with a plurality of financial products, each said financial product being supplied by a financial product supplier having a commission agreement with said broker, including the step of: entering into an agreement with said customer, said agreement including a promissory obligation by the broker to pay to the customer an amount based on a commission payable to the broker by a financial product supplier of a financial product, said financial product being selected by said customer, and a promissory obligation by the customer to pay a service fee to said broker, said service fee being based on the value of brokering services provided.

Preferably said amount includes a variable amount.

Preferably said broker performs said promissory obligation by deducting said service fee from said commission and remitting the balance to said customer.

Preferably said commission includes an up-front commission and a trail commission.

Preferably said variable amount is 100% of said commission.

Said service fee may include a set-up fee and a maintenance fee, said set-up fee being associated with said up-front commission, said maintenance fee being associated with said trail commission.

Said service fee may include an amount calculated with reference to a tax rate.

Preferably a flat service fee applies to all financial products that are available through said broker.

Preferably said service fee is fixed.

In another embodiment said service fee is variable, based, at least in part, on one or more of the following: a number of financial products chosen by said customer; an amount of time required to transact said financial product; a cost of performing said transaction of said financial product; a service level; a category of said customer.

Preferably said method for providing brokering services further includes the step of disclosing of said commissions payable on said financial products.

Preferably said disclosure takes place before said customer commences said selection.

A second form of the present invention provides a method for providing brokering services by a broker to a customer including the step of calculating a true cost of a financial product, said calculation being performed with reference to a commission payable to said broker by a supplier of said financial product.

A third form of the present invention provides a method for providing brokering services by a broker to a customer including the step of: entering an agreement with said customer, said agreement including a promissory obligation by the broker to pay to the customer a variable amount based on a commission payable to the broker by a financial product supplier of a financial product, said financial product being selected by said customer, and a promissory obligation by the customer to pay a flat service fee to said broker.

A fourth form of the present invention provides a method for providing brokering services by a broker to a customer, said broker being associated with a plurality of financial products, each said financial product being provided by a financial product supplier having a commission agreement with said broker, including the steps of: entering into an agreement with said customer, said agreement including: a promissory obligation by the broker to enter into an agreement with a financial product supplier, a financial product of said financial product supplier being selected by said customer, said agreement requiring said financial product supplier to pay to the customer a variable amount based on a commission, said commission being otherwise payable to said broker, and a promissory obligation by the customer to pay a service fee to said broker, said service fee being based on value of brokering services provided.

A fifth form of the present invention provides a method for selecting a financial product from a plurality of financial products, each said financial product being provided by a financial product supplier, a product selection facility for said selection being provided by a broker, said product selection being performed by a customer, said product selection facility being capable of disclosing parameters of said financial products, wherein the identity of any product supplier with whom the broker does not have a broker agreement, and (or) the identity of any financial product supplied by a product supplier with whom the broker does not have a broker agreement is not disclosed during the process of product comparison.

Preferably said method for selecting a financial product from a plurality of financial products further includes the step of revealing the identity of said financial product supplier and (or) the identity of said financial product in return for a consultancy fee payable by the customer to said broker.

A sixth form of the present invention provides a method for selecting a financial product from a plurality of financial products, each said financial product being provided by a financial product supplier, a product selection facility for said selection being provided by a broker, said product selection being performed by a customer, said product selection facility being capable of disclosing parameters of said financial products, wherein identities of said financial product suppliers and (or) identities of said financial products are not disclosed during the process of product comparison.

A seventh form of the present invention provides a method for providing brokering services by a broker to a customer including the step of calculating a true cost of a financial product, said calculation being performed with reference to a pay per use feature of a financial product.

An eighth form the present invention provides a method of providing brokering services by a broker to a customer, said broker being associated with a plurality of financial product providers each providing one or more financial products, the method including the broker collating financial product parameters for each financial product to determine a financial product characteristic for each financial product, ranking the financial products according to their financial product characteristics, the customer selecting a financial product, the broker and customer entering an agreement, said agreement including a promissory obligation by the broker to pay to the customer an amount based on a commission payable to the broker by a financial product supplier of the selected financial product, and a promissory obligation by the customer to pay a service fee to said broker, said service fee being based on the value of brokering services provided.

Preferably said method includes the step of collating customer eligibility information and comparing the customer eligibility information against customer eligibility criteria established by each financial product supplier.

A ninth form of the present invention provides a financial product matching database system for matching a plurality of financial product requests provided by customers to a plurality of financial products provided by a plurality of financial product suppliers, said system including:
a computer processor;
a financial product database capable of storing financial data in a form readable by said processor, said financial data including commissions payable by said financial product suppliers on said financial products;
database management tools for use by a broker and or by said customers to manage the financial product requests in said database including:
a tool for creating a financial product request;
a tool for creating and modifying requirements for said financial request;
financial product management tools for use by said broker and or by said financial product suppliers to create and modify financial product characteristics specific to said financial products provided by said financial product suppliers;
a software tool using said financial data, said financial product requests and said financial product characteristics to form a product query;
a search tool searching said financial products in said product matching database to return financial products compatible with said product query.

Preferably said software tool uses said financial data, said financial product requests and said financial product characteristics to calculate a product parameter relating to a financial product, said calculation being performed with reference to a commission payable on said financial product.

Preferably said product parameter is an interest rate.

Preferably said financial products are ranked by said product parameter.

A further form of the present invention provides, in a financial product matching database system for matching a plurality of financial product requests provided by customers to a plurality of financial products supplied by a plurality of financial product suppliers, a method for selecting a financial product, said method including the step of:
calculating a product parameter relating to a financial product, said calculation being performed with reference to a commission payable on said financial product.

Preferably said product parameter is an interest rate.

Preferably said method further includes the step of ranking said financial products by said product parameter.

A further form of the present invention provides a method of using a computer system for selecting a financial product from a plurality of financial products stored in a database, said method including the steps of:
inputting data into the computer system, said data including commissions payable on each of the products;
using the computer system to calculate a product parameter for each of the products, said calculation being performed with reference to said commissions payable on said product; and
using the computer system to rank said products based on said product parameter.

### BRIEF DESCRIPTION OF THE DRAWINGS

An embodiment or embodiments of the present invention will now be described, by way of example only, with reference to the accompanying drawings, in which:

FIG. 1 is a schematic diagram showing the overall method of the present invention;

FIG. 2 illustrates a range of products available to a customer;

FIG. 3 is a schematic diagram showing the operation of the method of the present invention in relation to an up-front commission of 0.06% for a loan of $300,000;

FIG. 4 is a schematic diagram showing the operation of the method of the present invention in relation to a trail commission of 0.1% for a loan of $300,000;

FIG. 5 is a schematic diagram showing the operation of the method of the present invention in the context of loan comparison; and

FIG. 6 illustrates an embodiment of the present invention.

### DETAILED DESCRIPTION OF THE EMBODIMENT(S)

The method for providing mortgage brokering services described in the present invention is intended for use by a borrower wishing to finance a purchase of a property and a mortgage broker working with the borrower to obtain a loan from a mortgage lender.

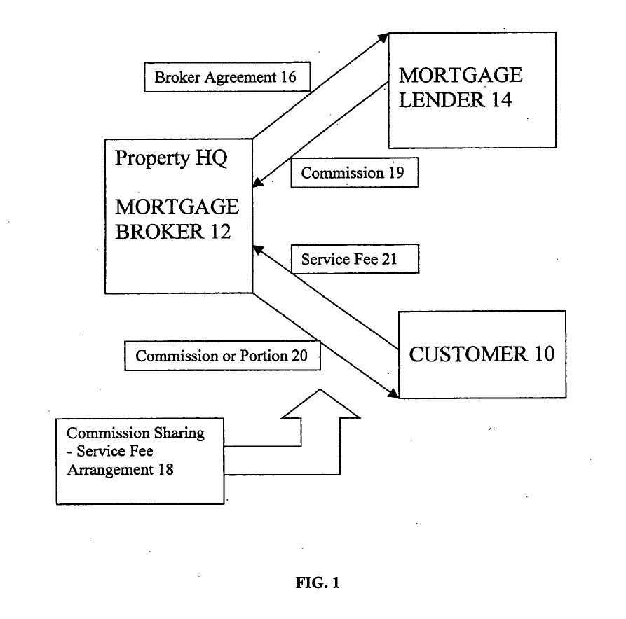

FIG. 1 depicts the overall method of the present invention and identifies the major participants of a mortgage brokering service, including a borrower 10, a mortgage broker 12 (“Property HQ”), and an affiliated mortgage lender 14. The term ‘affiliated mortgage lender’ refers to a mortgage lender having a broker agreement with the mortgage broker 12.

The new method of providing mortgage brokering services links a traditional commission-based arrangement 16 (‘an introducer agreement’ or ‘broker agreement’) between the mortgage broker 12 and the mortgage lender 14 to a new business relationship 18 between the mortgage broker 12 and the customer 10 characterised by sharing benefits resulting from the traditional commission-based arrangement 16.

In mortgage brokering arrangements created with the subject invention, the mortgage lender 14 retains the traditional obligation of paying a commission 19 to the mortgage broker 12, but the mortgage broker 12 surrenders a quantum 20 of the commission 19 to the borrower 10 in return for a service fee 21 paid by the borrower 10.

In another embodiment (not shown), the mortgage broker 12 enters into an agreement with the mortgage lender 14, the agreement requiring the mortgage lender 14 to pay to the borrower 10 a commission (or its equivalent) otherwise payable to the mortgage broker 12.

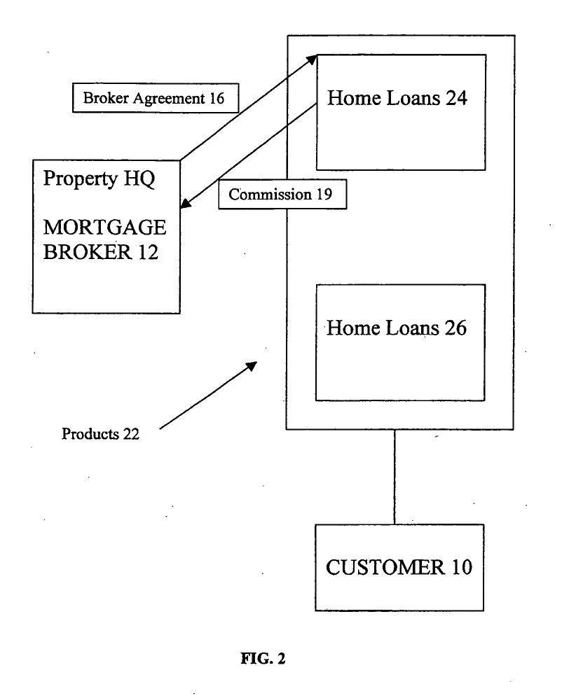

As shown in FIG. 2, the mortgage broker 12 may offer a number of products 22 (eg, home loans) including:
(a) home loans 24 from affiliated mortgage lenders, and
(b) home loans 26 that are not available through the mortgage broker 12.

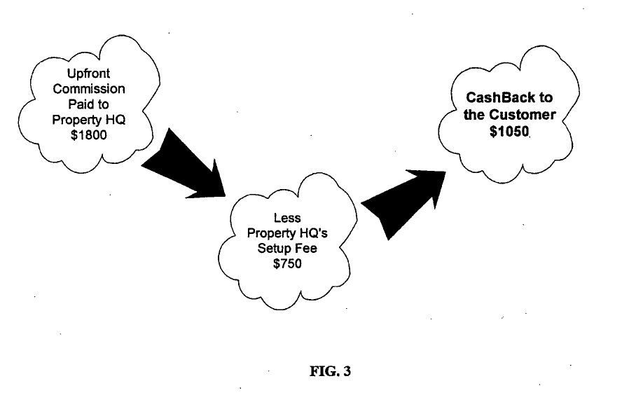

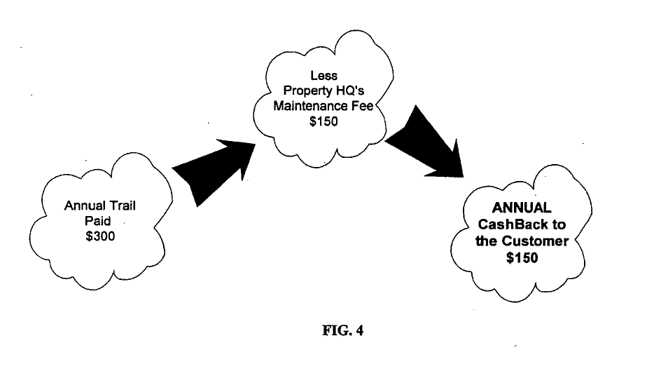

The operation of the present invention in relation to the home loans 24 from affiliated mortgage lenders is illustrated in FIGS. 3 and 4.

In the following example a customer borrows $300,000 through Property HQ's mortgage brokering service. The commissions payable to the mortgage broker by the mortgage lender are as follows:
an up front commission is 0.6% (300,000*0.6%=$1,800) a trail commission is 0.1% (300,000*0.1%=$300.

The customer agrees to pay to Property HQ a set up fee of $750.00. The set up fee may be paid before the process of loan selection starts or upon selecting a suitable home loan. Alternatively, the set up fee may be debited to a customer account with said mortgage broker. Upon receiving of the up-front commission from the mortgage lender, Property HQ pays $1,050 (1,800-750=$1,050) to the customer.

The Property HQ set-up fee varies in accordance with the complexity of the customers lending arrangements (eg, the amount of work involved in brokering a loan), not the amount borrowed or the lender that the loan is placed with. This fee is fully disclosed to the customer prior to submitting any loan application to a lender. On some loan products, Property HQ may also pay the loan application fee on the customers behalf and deduct it from the commission portion paid to the customer.

FIG. 4 illustrates the calculation of the trail commission portion payable to the customer. The trail commission portion is calculated by deducting a maintenance fee from the amount of the trail commission.

Trail commissions are calculated on the outstanding balance of the loan. As the outstanding balance falls, the trail commission will decline also. Once the trail commission falls below the Property HQ maintenance fee, the payments of the trail commission portion will cease.

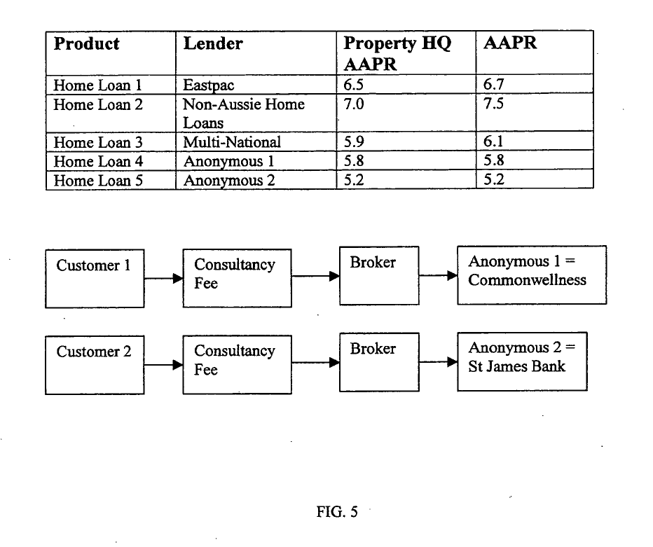

FIG. 5 illustrates the operation of the present invention in the context of loan comparison and selection.

Most mortgage broker organisations often have affiliation with a number of mortgage lenders. These multiple affiliated lenders are commonly referred to as the “Lender Panel”.

In an example illustrated in Table 1, Property HQ mortgage brokering service is affiliated with several mortgage lenders: Lender A, Lender B, Lender C, Lender D, and Lender E. As shown in Table 1, the lenders offer the following up-front commissions and interest rates:

TABLE 1

| | Up-front | | | |
|---|---|---|---|---|
| | Commission | | | Commission |
| | on $500,000, | Interest rate, | | portion paid to |
| Lender | %/$ | % | Set-up fee, $ | the customer, $ |
| Lender A | 0.6/3,000 | 5.9 | 750 | 2,250 |
| Lender B | 0.5/2,500 | 5.5 | 750 | 1,750 |
| Lender C | 1/5,000 | 6.0 | 750 | 4,250 |
| Lender D | 0.5/2,500 | 5.4 | 1,000 | 1,500 |
| Lender E | 0.6/3,000 | 5.9 | 850 | 2,150 |

A traditional mortgage broker may favour Lender C providing the highest up-front commission of $5,000, while a Property HQ mortgage broker will get the same service fee of $750 for a home loan provided by Lender A, B, or C. Property HQ's service fee is deducted from the commission—all surplus commissions are paid back to the customer by property HQ or the Lender. As a result, any financial bias that a Property HQ mortgage broker may have towards Lender C is completely removed.

As shown in Table 1, the Property HQ mortgage broker charges a higher service fee in cases of Lender D and Lender E. This may be caused by the fact that the effort involved in placing a loan with these lenders is higher than in cases of Lenders A, B, and C. However the level of service fee does not depend on the amount of commission paid by the lender.

Table 2 demonstrates how the method of the present invention operates in relation to the size of a loan:

TABLE 2

| | Up-front | Interest | Set-up | Commission |
|---|---|---|---|---|
| Customer | Commission | rate, | fee, | portion paid to |
| @ amount borrowed | @ 0.6%, $ | % | $ | the customer, S |
| Customer A @500,000 | 3,000 | 5.5 | 750 | 2,250 |
| Customer B @200,000 | 1,200 | 5.5 | 750 | 450 |
| Customer C @350,000 | 2,100 | 5.5 | 750 | 1,350 |
| Customer C @300,000 | 1,800 | 5.5 | 750 | 1,050 |
| Customer D @200,000 | 1,200 | 5.5 | 1,000 | 200 |

A traditional mortgage broker may encourage customer C to borrow $350,000 instead of $300,000 so as to increase his or her up-front commission from $1,800 to $2,100. A property HQ mortgage broker receives the same set up fee of $750 irrespective of whether Customer C borrows $300,000 or $350,000. As a result, the method of the present invention discourage excessive borrowing.

As shown in Table 2, Customer D borrowing the same amount—$200,000—as Customer B has paid a set-up service fee of $1,000 instead of $750. Such disparity may be caused, for example, by the fact that customer D is self employed. It is likely that a traditional mortgage broker will place Customer D in a “no doc” or “lo doc” loan usually carrying higher interest rates. As no income evidence or verification is required for such loans, the traditional mortgage broker will eliminate a major part of the paperwork and management effort required from him or her while still receiving the full commission.

A Property HQ mortgage broker may be able to find a better loan for Customer D in return for an increased service fee.

The examples illustrated in Tables 1 and 2 clearly demonstrate that the new method for providing mortgage brokering services establishes a clean ‘payment for effort’ model that completely and effectively removes financial incentives for a broker to favour a specific lender or product or to encourage the customer into increased borrowings to the benefit of the broker.

Up-front commissions can be used to meet the set up fee. If up-front commissions are too low to meet the set up fee, additional costs from the set up fee can be shifted to the maintenance fee.

Property HQ offers full, up-front disclosure on all fees and commissions for all lenders on their panel, not just the lender for the selected loan, to further inform the customer and ensure that there are no hidden incentives to the mortgage broker. In particular, a computer-implemented method of the present invention involves the step of calculating a ‘true’ cost of a product with reference to commissions payable by the lender in relation to the product.

In another embodiment, a computer-implemented method of the present invention includes the step of calculating a ‘true’ cost of a product with reference to one or more pay per use features of the product.

The method of the present invention takes into account the Customers anticipated usage of these features, extrapolates the cost based on the usage versus the differently costed options available in the market place and ranks the matched products based on these costs (the Real Cost). Under this model the Customer is then in a position to have the most accurate reflection of the cost of their loan available forecast over the life of the loan.

For example, Customers A and B have home loans with outstanding balances of $250,000 with a remaining term of 25 years. Each of the Customers has a surplus income of say $400 per week and they pay their loans monthly.

For this type of Customer, a redraw facility that enables a Customer to access any funds deposited above the scheduled repayment has the potential to be highly effective for each of them. By using this facility well, a Customer can keep the savings component of their income deposited in their home or investment loan account, thereby avoiding incurring mortgage interest against these monies. This has the effect of producing a nett return equal to that of the interest rate charged against the mortgage for that money, which is for most people, a highly effective investment return for simple savings.

Customer A manages their money quite effectively under a simple system of separating savings from monies used for expenses. As a consequence, Customer A partitions $400 per week into a separate savings account. They expect to draw back on these savings between once and twice per year, once being for their annual holidays and the second occasions factored in for unforeseen circumstances.

Customer B on the other hand, makes larger, regular deposits, using their mortgage account as more of a transaction account. They draw back on these funds between once and twice per month.

Assume that a test of their requirements reduces the list of ‘ideal’ products to two. Product A has a basic interest rate of say 6.00% and the redraw facility is available on a pay per use basis of $40. Product B is a standard variable rate and the redraw service is included in a loaded rate of 0.1% above that of Product A.

In this example and assuming there are no other fees associated with Product A or Product B, the Real Cost for both Customers of Product B is $487,821.01.

However the Real Cost of Product A varies for each of the Customers as it also includes the Pay Per Use Fees.
Real Cost=(Number of Times Used per annum×Per Use Charge×Term (Number of years))+Raw Loan Cost

Customer A:
Real Cost=(2×$40×25)+$483,226.05=$485, 226.05

Customer B:
Real Cost=(26×$40×25)+$483,226.05=$509,226.05

In the example given, the solution that the PHQ Loan Selector would rank superior for Customer A is Product A as the Real Cost of this product is $485,226.05 which is $2594.96 cheaper that Product B.

Similarly, Product B would rank superior to Product A for Customer B as the real cost of Product B is $487,821.01 which is $21,405.04 cheaper than Product A.

As can be seen from the above example, the real cost of the same product from the same lender for different Customers can vary significantly or be exactly the same.

The loan selection software compares a set of loans that meet the customers product requirements, and then lists those products that fit the customers criteria in customisable order, which is most commonly, price. In industry terms, price is known as the Annualised Average Percentage Rate (AAPR). The AAPR—also known as the comparison or true rate—is a figure designed to show the ‘true’ cost of a loan, taking into consideration up-front fees, honeymoon rates, ongoing fees, different compounding periods and other factors.

The Property HQ AAPR further includes service fees and commissions payable to the broker, both in terms of up-front commissions and trail commissions. Similarly, the Property HQ AAPR can include an adjustment relating to pay per use features.

Furthermore, while the current market practice is that loan comparison and selection is based on evaluation against the Mortgage Brokers Lender Panel which includes affiliated lenders only, the method of the present invention is designed to meet the broader objective of serving the customer's interests.

This objective dictates that the customers requirements must be considered across a broader spectrum of lenders than the Mortgage Brokers Lender Panel to eliminate a biased and restricted comparison.

To this end, all lenders offering relevant loan products to customers and making their product information available to Property HQ via an information aggregating facility (eg, CANNEX) can be included in the PHQ Loan Selector regardless of whether there is a standing broker/introducer agreement with Property HQ or not.

The Property HQ Loan Selector may “pre-qualify” the customer in accordance with the individual lender's lending criteria for all lenders to provide a sound, indicative likelihood of success of the loan application. Any products that the customer does not clearly qualify for will be excluded from the loan comparison phase.

A financial product matching database system according to the present invention includes a computer processor, a data storage/memory holding a financial product database storing financial data in a form readable by the computer processor and a software tool to be used in the system of the present invention.

The financial data stored in the financial product database can include identities of financial products (eg, Home Loan HL1, Home Loan “MYHOUSE”, Credit Card CD 7, Line of credit LC 4, Personal Loan “MYYACHT”, etc), identities of financial product suppliers (eg, Bank B1, Bank “Advance”, Credit Society CS5, Financial Company “YES”, etc), product characteristics (commissions payable on products, fixed and variable interest rates, top-ups, redraw facility, repayment holidays, penalties, etc).

The software described herein is also stored in the data storage/memory, and is also executed on the database computer system.

The database system can include one or more financial request interface means including data entry devices operable by a broker and or by prospective customers for creating, modifying, and communicating financial product request requirements to the database system. The broker and or the customer enters onto a form the details of the financial product requirements such as the type of finance (eg, a Home Loan, a Credit Card), an amount, top-ups, redraw facility, repayment holidays, preferred method of repayment (eg, direct debit), limitations on products (eg, max interest rate, ongoing fees, application fee or establishment fee), etc).

The computer database system receives the financial product request and automatically saves the financial product request requirements in the financial product database for subsequent searching by the broker (or by the customer upon a payment of a search fee).

Likewise, the financial product database system can include one or more financial product interface means and entry devices operable by the broker and or by financial product suppliers for creating, modifying, and communicating financial product characteristics (identities of financial products, commissions, interest rates, terms of loans, ongoing fees, valuation fees, application fees, redraw facility, repayment holidays, pay per use features, top-ups, etc) to the database system.

The information provided by the customer forms search terms for querying the financial product database by using the software tool to automatically select financial products compatible with the customer's request. When the financial product database is queried, it returns, in the form of a table, a summary of search results covering financial products matching product characteristics specified by the customer.

The software used in the database system can be used to calculate a financial product parameter relating to a financial product based on a commission payable on the product. For example, such a product parameter can be a loan term or a “true” interest rate of the financial product calculated with reference to the up-front and trail commissions payable on the product by the product supplier of the product.

The financial products can be ranked by the calculated product parameter. Table 3 illustrates the operation of the present invention in the context of ranking financial products A and B based on Loan Term and or Total Cost.

TABLE 3

| | Product A | Product B |
|---|---|---|
| Loan amount, $ | 300,000 | 300,000 |
| Up-front commission, $ | 5,000 | 6,000 |
| Service Fee, $ | 1,000 | 1,000 |
| Borrowed amount, $ | 296,000 = (300,000 − | 295,000 = (300,000 − |
| | 5,000 + 1,000) | 6,000 + 1,000) |
| Interest rate, % | 7.07 | 7.07 |
| Loan term, years | 20 | 19 years 11 months |
| Repayments, $ | 2,308 (monthly) | 2,308 (monthly) |
| Total interest paid, $ | 257,934.00 | 255,976.00 |
| Ranking based on total | 2 (300,000 + 257,934) | 1 (300,000 + 255,976) |
| cost | | |
| Ranking based on loan | 2 | 1 |
| term | | |

Other product parameters may include a “true” interest rate (or a true cost of borrowing) of the financial product calculated with reference to pay-per-use features of the product.

It will be appreciated by those skilled in the art that different methods can be used to calculate a “true” interest rate (or a true cost of borrowing) (e.g. actuarial methods, methods relating to “present value”, “future value”, etc).

Products fulfilling the customers requirements will be ranked against an “open market”, limited only by available information rather than the Property HQ Lender Panel. As the products are compared on an even playing field in relation to features (ATM/Branch Access, Available Repayment Terms, Redraw, and Fixed Rates etc), and flexibility of the product, the single differentiator that can be independently ranked is price (although some customers may have preferences to go with or avoid a particular lender).

It is quite possible and perhaps even likely that there will be products available that cannot be matched or beaten by Property HQ Panel Lenders. As shown in FIG. 5, the Lender and Loan Product for non-Panel Lenders will be hidden from view, whilst all other key information such as AAPR, Property HQ AAPR, Cost Of Loan over Full Term and the Cost Of the Loan over a specified Term will be available to the customer.

The Customer then has the following options available:
1. Apply for a Loan with a Lender on the Property HQ Lender Panel;
2. Pay a consultancy fee to the Property HQ Field Consultant to reveal the Lender and relevant product;
3. Embark on a search for that currently anonymous lender and product without paying any fee to Property HQ.

As a result, the customer is empowered to make an informed decision about his or her financial arrangements.

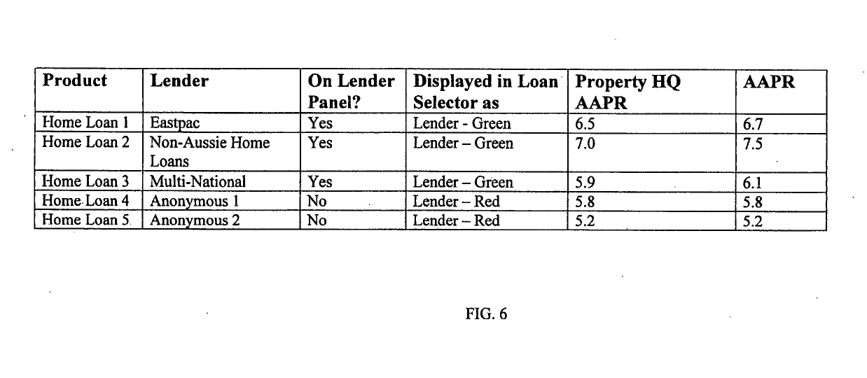

In an alternative embodiment illustrated in FIG. 6 lender anonymity is preserved across all lenders, regardless of whether they are ‘on’ or ‘off’ panel, so that lender names and financial product names are not known by either the broker or the customer. Lenders that are a part of the Panel are highlighted in Green, those that are not are highlighted in Red.

Customers can be surveyed for their level of satisfaction both on the performance of the broker and also the performance of the lender on an annual basis. Lender data is incorporated into the PHQ Loan Selector for evaluation by the Customer on selection of the appropriate lender/product combination. Aspects that are factored into this process include, but are not limited to:
A lender's willingness to assist the Customer
A lender's ability to understand the Customer's enquiry
A lender's ability to direct the Customers' to the right person
A general rating of Customer satisfaction.
Responsiveness of rate adjustments following an increase in the target cash rate
Responsiveness of rate adjustments following a decrease in the target cash rat.

The responsiveness of rate adjustments are factored in at a system level rather than in reliance on Customer feedback.

On selection of a particular lender/product combination, the Customer also receives a report on how that particular lender performed in the respective areas against the average, best and worst for all loans written through the broker.

It will be appreciated by those skilled in the art that the new method of providing brokering services is by no means limited to mortgage brokering. The invention may also be used in the insurance industry, the commercial finance and leasing segments of the finance industry, and many other brokering services.

Similarly, the scope of the present invention is not limited to brokers as such. In particular, the present invention may also be used by mortgage lenders.

It will be understood that the invention disclosed and defined herein extends to all alternative combinations of two or more of the individual features mentioned or evident from the text. All of these different combinations constitute various alternative aspects of the invention.

While particular embodiments of this invention have been described, it will be evident to those skilled in the art that the present invention may be embodied in other specific forms without departing from the essential characteristics thereof. The present embodiments and examples are therefore to be considered in all respects as illustrative and not restrictive, and all modifications which would be obvious to those skilled in the art are therefore intended to be embraced therein.

1. A method for providing brokering services by a broker to a customer, said broker being associated with a plurality of financial products, each said financial product being supplied by a financial product supplier having a commission agreement with said broker, including the step of:
entering into an agreement with said customer, said agreement including a promissory obligation by the broker to pay to the customer an amount based on a commission payable to the broker by a financial product supplier of a financial product, said financial product being selected by said customer, and
a promissory obligation by the customer to pay a service fee to said broker, said service fee being based on value of brokering services provided.

2. A method according to claim 1 wherein said amount includes a variable amount.

3. A method according to claim 1, wherein said broker performs said promissory obligation by deducting said service fee from said commission and remitting the balance to said customer.

4. A method according to claim 1, wherein said commission includes an up-front commission and a trail commission.

5. A method according to claim 2, wherein said variable amount is 100% of said commission.

6. A method according to claim 4, wherein said service fee includes a set-up fee and a maintenance fee, said set-up fee being associated with said up-front commission, said maintenance fee being associated with said trail commission.

7. A method according to claim 1, wherein said service fee includes an amount calculated with reference to a tax rate.

8. A method according to claim 1 wherein a flat service fee applies to all financial products that are available through said broker.

9. A method according to claim 1 wherein said service fee is fixed.

10. A method according to claim 1 wherein said service fee is variable, based, at least in part, on one or more of the following: a number of financial products chosen by said customer; an amount of time required to transact said financial product; a cost of performing said transaction of said financial product; a service level; a category of said customer.

11. A method according to claim 1 further including the step of disclosing of said commissions payable on said financial products.

12. A method according to claim 11 wherein said disclosure takes place before said customer commences said selection.

13. A method for providing brokering services by a broker to a customer including the step of calculating a true cost of a financial product, said calculation being performed with reference to a commission payable to said broker by a supplier of said financial product.

14. A method for providing brokering services by a broker to a customer including the step of calculating a true cost of a financial product, said calculation being performed with reference to a pay per use feature of a financial product.

15. A method for providing brokering services by a broker to a customer including the step of:
entering an agreement with said customer, said agreement including
a promissory obligation by the broker to pay to the customer a variable amount based on a commission payable to the broker by a financial product supplier of a financial product, said financial product being selected by said customer, and
a promissory obligation by the customer to pay a flat service fee to said broker.

16. A method for providing brokering services by a broker to a customer, said broker being associated with a plurality of financial products, each said financial product being provided by a financial product supplier having a commission agreement with said broker, including the steps of:
entering into an agreement with said customer, said agreement including
a promissory obligation by the broker to enter into an agreement with a financial product supplier, a financial product of said financial product supplier being selected by said customer, said agreement requiring said financial product supplier to pay to the customer a variable amount based on a commission, said commission being otherwise payable to said broker, and
a promissory obligation by the customer to pay a service fee to said broker, said service fee being based on value of brokering services provided.

17. A method for selecting a financial product from a plurality of financial products, each said financial product being provided by a financial product supplier, a product selection facility for said selection being provided by a broker, said product selection being performed by a customer, said product selection facility being capable of disclosing parameters of said financial products, wherein the identity of any product supplier with whom the broker does not have a broker agreement, and (or) the identity of any financial product supplied by a product supplier with whom the broker does not have a broker agreement is not disclosed during the process of product comparison.

18. A method according to claim 17 further including the step of revealing the identity of said financial product supplier and (or) the identity of said financial product in return for a consultancy fee payable by the customer to said broker.

19. A method for selecting a financial product from a plurality of financial products, each said financial product being provided by a financial product supplier, a product selection facility for said selection being provided by a broker, said product selection being performed by a customer, said product selection facility being capable of disclosing of parameters of said financial products, wherein identities of said financial product suppliers and (or) identities of said financial products are not disclosed during the process of product comparison.

20. A method of providing broking services by a broker to a customer, said broker being associated with a plurality of financial product suppliers each providing one or more financial products, the method including the broker collating financial product parameters for each financial product to determine a financial product characteristic for each financial product, ranking the financial products according to their financial product characteristics, the customer selecting a financial product, the broker and customer entering an agreement and implementing the subsequent steps of claim 1.

21. A method as claimed in claim 20 further including the step of collating customer eligibility information and comparing the customer eligibility information against customer eligibility criteria established by each financial product supplier.

22. A financial product matching database system for matching a plurality of financial product requests provided by customers to a plurality of financial products provided by a plurality of financial product suppliers, said system including:
a computer processor;
a financial product database capable of storing financial data in a form readable by said processor, said financial data including commissions payable by said financial product suppliers on said financial products;
database management tools for use by a broker and or by said customers to manage the financial product requests in said database including a tool for creating a financial product request and a tool for creating and modifying requirements for said financial request;
financial product management tools for use by said broker and or by said financial product suppliers to create and modify financial product characteristics specific to said financial products provided by said financial product suppliers;
a software tool using said financial data, said financial product requests and said financial product characteristics to form a product query;
a search tool searching said financial products in said product matching database to return financial products compatible with said product query.

23. A system according to claim 22 wherein said software tool uses said financial data, said financial product requests and said financial product characteristics to calculate a product parameter relating to a financial product, said calculation being performed with reference to a commission payable on said financial product.

24. A system according to claim 23 wherein said product parameter is an interest rate.

25. A system according to claim 23 wherein said financial products are ranked by said product parameter.

26. In a financial product matching database system for matching a plurality of financial product requests provided by customers to a plurality of financial products supplied by a plurality of financial product suppliers, a method for selecting a financial product, said method including the step of calculating a product parameter relating to a financial product, said calculation being performed with reference to a commission payable on said financial product.

27. A method according to claim 26 wherein said product parameter is an interest rate.

28. A method according to claim 26 further including the step of ranking said financial products by said product parameter.

29. A method of using a computer system for selecting a financial product from a plurality of financial products stored in a database, said method including the steps of:
inputting data into the computer system, said data including commissions payable on each of the products;
using the computer system to calculate a product parameter for each of the products, said calculation being performed with reference to said commissions payable on said product; and
using the computer system to rank said products based on said product parameter.
